(19) United States
(12) Patent Application Publication
(10) Pub. No.: US 2023/0230730 A1
(43) Pub. Date: Jul. 20, 2023

(54) FEEDTHROUGH

(71) Applicant: ASCEND DIAGNOSTICS LIMITED, Manchester (GB)

(72) Inventor: Alex GWEN-HAM HO, Manchester (GB)

(21) Appl. No.: 17/998,582

(22) PCT Filed: Jun. 4, 2021
(86) PCT No.: PCT/GB2021/051391

§ 371 Date: Nov. 11, 2022

(30) Foreign Application Priority Data
Jun. 5, 2020 (GB) 2008480.2

(51) Int. Cl. H01B 17/30; H02G 3/22; G02B 6/42; F16L 5/06

(52) U.S. Cl. CPC H01B 17/303; H02G 3/22; G02B 6/4248; F16L 5/06

(57) ABSTRACT

A feedthrough (10) for an element (100) is described, comprising: a body (500), a cap assembly, comprising a cap (200) and optionally a follower (300), and a sealant (400), having respective passageways therethrough, defining an axis A, for receiving the element (100) therethrough; wherein the body (500) is couplable to a wall W of a hermetically-sealed vessel V having an aperture A for the element (100) therethrough and wherein the passageway of the body (500) is adapted to retain, at least in part, the sealant 400 and optionally the follower (300) therein; wherein the cap (200) is releasably couplable to the body (500); wherein the feedthrough (10) is configurable in: a first configuration, wherein the cap (200) is coupled to the body (500), wherein matching faces of the cap assembly and the body (500) are mutually spaced apart by a gap and wherein the element (100) extends through the respective passageways; and a second configuration, wherein the cap (200) is coupled to the body (500), wherein the matching faces (230, 520) of the cap assembly and the body (500) abut and wherein the element (100) extends through the respective passageways; wherein the cap assembly is adapted to axially compress the sealant (400) against the body (500), thereby causing the sealant (400) to radially compress against the element (100) and to form a hermetic seal between the body (500) and the element (100), in the second configuration.

### FIELD

The present invention relates to a feedthrough for an element, for example an electrical cable, a fibre optical cable or a pipe, for a hermetically-sealed vessel.

### BACKGROUND TO THE INVENTION

Generally, feedthroughs are used to provide coupling, including electrical, optical, fluid and/or mechanical coupling, through walls of hermetically-sealed vessels, for example pressure vessels and vacuum chambers. Feedthroughs for vacuum chambers may be known as vacuum feedthroughs. For example, an electrical feedthrough allows voltages to be applied to components in a vacuum chamber via an electrical cable through a wall of the vacuum chamber. For example, an optical feedthrough enables an optical fibre to pass through a wall of a vessel, for example for data transmission. For example, a fluid feedthrough permits gases to flow into a devices, such as a collision or reaction cell, inside a mass spectrometer via a tube through a wall of the mass spectrometer. For example, a mechanical feedthrough may be used for manipulation such as rotation and/or translation of components in a pressure vessel. Analytical instrumentation, such as mass spectrometers and electron microscopes, typically includes components operating at high voltages, HV, for example from 2 kV to 30 kV, at pressures typically in a range from 1×10⁻⁵ mbar to 1×10⁻¹⁰ mbar. Shielded co-axial cables are typically used to transmit these high voltages. Hence, HV electrical feedthroughs for such analytical instrumentation must provide electrical isolation while maintaining vacuum integrity. Generally, conventional HV electrical feedthroughs are classified as non-breaking or breaking, while both are typically directly (and permanently) coupled to respective HV power supply units, PSUs. For example, a HV PSU may include a co-axial cable, having one end directly coupled to the HV PSU and a non-breaking HV electrical feedthrough directly coupled at the other end. That is, the HV PSU, the co-axial cable and the non-breaking HV electrical feedthrough are integrally formed (i.e. non-separable). The non-breaking HV electrical feedthrough typically includes a metal flange, for mechanically coupling to a wall of a vacuum chamber, and an insulated (usually using ceramic) electrical conductor that extends from the co-axial cable, through the feedthrough and into the vacuum chamber. Another cable is then used to electrically couple this electrical conductor of the non-breaking HV electrical feedthrough to a component inside the vacuum chamber. For example, a HV PSU may include a co-axial cable, having one end directly coupled to the HV PSU and a co-axial fitting directly coupled at the other end. The co-axial fitting is releasably couplable to a corresponding coaxial fitting of a breaking HV electrical feedthrough. That is, the HV PSU, the co-axial cable and the co-axial fitting are integrally formed while the breaking HV electrical feedthrough is separable therefrom. The breaking HV electrical feedthrough typically includes a metal flange, for mechanically coupling to a wall of a vacuum chamber, and an insulated (usually using ceramic) electrical conductor that extends from the corresponding co-axial fitting, through the feedthrough and into the vacuum chamber. Another cable is then used to electrically couple this electrical conductor of the breaking HV electrical feedthrough to a component inside the vacuum chamber.

However, non-breaking and breaking HV electrical feedthroughs are relatively complex and/or costly, for example due to use of ceramic insulators and/or maintaining vacuum integrity at interfaces between the ceramic insulators and metal flanges while limiting servicing and/or disassembly thereof. Further, a fault or damage to a non-breaking HV electrical feedthrough may require replacement of the HV PSU, since the HV PSU, the co-axial cable and the non-breaking HV electrical feedthrough are non-separable. While a breaking HV electrical feedthrough overcomes this particular limitation, the breaking HV electrical feedthrough includes two further electrical connectors, in addition to the electrical connector required inside the vacuum chamber, thereby further adversely affecting a resistance, capacitance and/or inductance thereof. In addition, a length of a breaking HV electrical feedthrough increases with voltage. For example, the length of a breaking HV electrical feedthrough, including required bending radius of the co-axial cable, may exceed 20 cm for a 10 kV rating and may exceed 30 cm for a 20 kV rating, thereby precluding use thereof due to size.

Hence, there is a need to improve feedthroughs for elements, for example electrical cables, fibre optical cables and/or pipes.

### SUMMARY OF THE INVENTION

It is one aim of the present invention, amongst others, to provide a feedthrough which at least partially obviates or mitigates at least some of the disadvantages of the prior art, whether identified herein or elsewhere. For instance, it is an aim of embodiments of the invention to provide a feedthrough that facilitates installation of an element through a wall of a hermetically-sealed vessel while reliably providing a hermetic seal. For instance, it is an aim of embodiments of the invention to provide a feedthrough that maybe repeatedly assembled and disassembled. For instance, it is an aim of embodiments of the invention to provide a feedthrough that reduces a number of connections required for the element. For instance, it is an aim of embodiments of the invention to provide a relatively smaller feedthrough, compared with conventional feedthroughs.

A first aspect provides a feedthrough for an element, comprising:

a body, a cap assembly, comprising a cap and optionally a follower, and a sealant, having respective passageways therethrough, defining an axis, for receiving the element therethrough;

wherein the body is couplable to a wall of a hermetically-sealed vessel having an aperture for the element therethrough and wherein the passageway of the body is adapted to retain, at least in part, the sealant and optionally the follower therein;

wherein the cap is releasably couplable to the body;

wherein the feedthrough is configurable in:

a first configuration, wherein the cap is coupled to the body, wherein matching faces of the cap assembly and the body are mutually spaced apart by a gap and wherein the element extends through the respective passageways; and

a second configuration, wherein the cap is coupled to the body, wherein the matching faces of the cap assembly and the body abut and wherein the element extends through the respective passageways;
wherein the cap assembly is adapted to axially compress the sealant against the body, thereby causing the sealant to radially compress against the element and to form a hermetic seal between the body and the element, in the second configuration.

A second aspect provides a kit of parts comprising a feedthrough according to the first aspect and an element, for example an electrical cable such as a coaxial cable, a fibre optical cable or a pipe such as a capillary tube.

A third aspect provides a hermetically-sealed vessel, for example a vacuum chamber or a mass spectrometer, comprising a feedthrough according to the first aspect and an element, for example an electrical cable such as a coaxial cable, a fibre optical cable or a pipe such as a capillary tube.

A fourth aspect provides a method of hermetically sealing an element through a wall of a hermetically-sealed vessel having an aperture for the element therethrough using a feedthrough according to the first aspect, the method comprising:

moving the feedthrough from the first configuration to the second configuration, until the matching faces of the cap assembly and the body abut, comprising axially compressing the sealant between the cap assembly and the body, thereby compressing the sealant radially against the element and forming a hermetic seal between the body and the element.

### DETAILED DESCRIPTION OF THE INVENTION

According to the present invention there is provided a feedthrough, as set forth in the appended claims. Also provided is a kit of parts, a hermetically-sealed vessel and a method. Other features of the invention will be apparent from the dependent claims, and the description that follows.

### Feedthrough

The first aspect provides a feedthrough for an element, comprising:

a body, a cap assembly, comprising a cap and optionally a follower, and a sealant, having respective passageways therethrough, defining an axis, for receiving the element therethrough;

wherein the body is couplable to a wall of a hermetically-sealed vessel having an aperture for the element therethrough and wherein the passageway of the body is adapted to retain, at least in part, the sealant and optionally the follower therein;

wherein the cap is releasably couplable to the body;

wherein the feedthrough is configurable in:

a first configuration, wherein the cap is coupled to the body, wherein matching faces of the cap assembly and the body are mutually spaced apart by a gap and wherein the element extends through the respective passageways; and

a second configuration, wherein the cap is coupled to the body, wherein the matching faces of the cap assembly and the body abut and wherein the element extends through the respective passageways;

wherein the cap assembly is adapted to axially compress the sealant against the body, thereby causing the sealant to radially compress against the element and to form a hermetic seal between the body and the element, in the second configuration.

In this way, since the matching faces of the cap assembly and the body abut in the second configuration, installation of the element through the wall of the hermetically-sealed vessel is facilitated while the hermetic seal between the body and the element, in the second configuration, is reliably provided. It should be understood that the hermetic seal between the body and the element is not formed in the first configuration but is formed upon moving the feedthrough from the first configuration to the second configuration. In more detail, by abutting the matching faces of the cap assembly and the body in the second configuration, an axial compressive strain applied by the cap assembly on the sealant (also known as a seal or sealing member), disposed between the cap assembly and the body, is controlled, thereby reliably providing the hermetic seal between the sealant and the body, without over compressing the sealant against the body. In turn, a radial compressive stress applied by the axially-compressed sealant on the element is controlled, thereby reliably providing the hermetic seal between the sealant and the element, without over compressing the sealant against the element, thereby reducing compression thereof or avoiding damage thereto. In this way, the sealant is thus hermetically sealed against the body and against the element. Particularly, by abutting the matching faces of the cap assembly and the body in the second configuration, the axial compressive strain of the sealant is a predetermined axial compressive strain defined by this second configuration, which may not be exceeded since the matching faces of the cap assembly and the body abut (i.e. touch, contact). Hence, by abutting the matching faces of the cap assembly and the body in the second configuration, a repeatable and predetermined axial compressive strain is applied on the sealant, thereby reliably sealing the sealant against the body. In turn, the radial compressive stress applied by the sealant on the element is similarly a repeatable and predetermined radial compressive stress. Hence, by moving the feedthrough to the second configuration, wherein the matching faces of the cap assembly and the body abut, installation of the element through the wall of the hermetically-sealed vessel is facilitated while the hermetic seal between the body and the element is reliably provided.

In this way, the feedthrough that maybe repeatedly assembled and disassembled, by moving the feedthrough from the first configuration to the second configuration and vice versa. For example, during maintenance to replace the feedthrough, the feedthrough may be moved from the second configuration to the first configuration and disassembled, the element replaced and the feedthrough subsequently reassembled, including moving from the first configuration to the second configuration, thereby sealing the feedthrough.

In this way, since the element extends through the feedthrough, a number of connections required for the element is reduced, enabling connections at the feedthrough to be eliminated. For example, an element such as a coaxial cable may extend from a power supply outside of the vessel, through the wall of the hermetically-sealed vessel via the feedthrough, to an electrical component inside the vessel, without any breaks or connections therebetween.

### Feedthrough

The feedthrough comprises the body, the cap assembly, comprising the cap and optionally a follower, and the sealant, having respective passageways therethrough, defining the axis, for receiving the element therethrough. It should be understood that the body, the cap assembly, the sealant and the elements are thus arranged coaxially, in use, wherein the element is received axially (i.e. along the axis) through the feedthrough. In one example, the element is received fully through the respective passageways. In one example, the element is slidably received through the respective passageways. In this way, the element may be inserted into the respective passageways and moved therethrough.

### Element

The feedthrough is for the element, for example an electrical cable such as a coaxial cable, a fibre optical cable or a pipe such as a capillary tube. Other elements are known. It should be understood that the feedthrough and the element are separable i.e. not integrally formed. In one example, the element is a continuous element, having no breaks therein. In one example, the element has a circular cross-section. In one example, the element comprises a plurality of layers and/or cores.

Typically, a coaxial cable comprises an inner conductor (also known as a centre core), for example a wire or a bundle of wires, surrounded by a concentric conducting screen or shield, for example a wire mesh or a metal foil, a dielectric or insulator therebetween and optionally, a protective outer sheath or jacket. Radial and/or axial stresses on the coaxial cable may result in shorting between the inner conductor and the conducting screen must and/or compromise and integrity of the screen, thereby resulting in interference due to or on a signal carried by the inner conductor. Hence, by controlling radial compression applied by the sealant on the element, such adverse effects are reduced and/or avoided.

Typically, an optical fibre comprises a core and a cladding layer, selected for total internal reflection due to the difference in the refractive index between the core and the cladding layer.

A protective coating may be provided on the cladding layer. Bundles of optical fibres may be assembled, optionally including buffer layers therebetween, having a protective outer sheath, to form a fibre optical cable. Radial and/or axial stresses on the optical fibre may affect the refractive index of the core and/or of the cladding layer, thereby adversely affecting transmission of light therealong. Hence, by controlling radial compression applied by the sealant on the element, such adverse effects are reduced and/or avoided.

Typically, a capillary tube comprises a cylindrical pipe having a single or multi-layered wall formed from a polymeric composition comprising a polymer or a metal, for example stainless steel. Radial and/or axial stresses on the capillary tube may result in flow restriction through the capillary tube and/or damage to the wall, for example. Hence, by controlling radial compression applied by the sealant on the element, such adverse effects are reduced and/or avoided.

### Vessel

In one example, the vessel comprises and/or is a vacuum chamber, for example for or of an analytical instrument, such as a mass spectrometer, or a process instrument, such as for semiconductor processing. In one example, the vessel comprises and/or is a pressure vessel. It should be understood that the wall of the vessel has the aperture therein for the element to be received therethrough i.e. from outside the vessel to inside the vessel. It should be understood that the vessel is hermetically sealed i.e. gas tight.

### Body

The body has the passageway therethrough for receiving the element therethrough. It should be understood that a dimension, for example an inner diameter, of the passageway of the body is thus at least a corresponding dimension, for example an outer diameter, of the element. In one example, the passageway of the body has a circular cross-section.

The body is couplable to a wall of the hermetically-sealed vessel having the aperture for the element therethrough. In one example, the body is separable from the wall, for example releasably couplable thereto. In this way, the body may be coupled to and uncoupled from (i.e. attached to and detached from) the wall. In one example, the body is non-releasably coupled to the wall. In this way, the body may be integrated with the wall, for example improving hermetic sealing therebetween. In one example, the body is integrally formed with the wall. In one example, the body is arranged to be mechanically coupled to the wall. In this way, the body may be repeatedly coupled to and uncoupled from the wall. In one example, the body is arranged to be welded to the wall. In this way, hermetic sealing between the body and the wall is improved.

In one example, the body is arranged to be mechanically coupled to the wall by comprising a flange, having a first face and an opposed second face, comprising a set of through holes for mechanical fasteners, wherein the first face is arranged to confront the wall and wherein the feedthrough assembly comprises a face seal (i.e. a static axial seal) for hermetically-sealing between the first face and the wall. In this way, the body may be coupled to and uncoupled from the wall, for example repeatedly, by fastening and unfastening the mechanical fasteners, respectively. In this way, hermetic sealing between the body and the wall is provided by the face seal disposed therebetween.

In one example, the face seal comprises and/or is an O ring, an E ring, a C ring, a gasket, such as an elastomeric gasket, a copper gasket or a gold gasket, or an end face mechanical seal. In one example, the face seal comprises and/or is a resilient seal. In one example, the face seal is generally as described with respect to the sealant.

In one example, the first face comprises a groove around the passageway, arranged to receive the face seal, for example an O ring, therein. In one example, the first face comprises a knife edge for sealing against a copper gasket, for example.

The passageway of the body is adapted to retain, at least in part, the sealant and optionally the follower therein, for example by having a first dimension, for example an inside diameter (also known as internal diameter), at a first end greater than a corresponding dimension, for example an outside diameter (also known as external diameter), of the sealant and the optional follower, whereby the sealant and the optional follower may be received therein via the first end of the passageway and a second dimension, for example an inside diameter, at a second end less than the corresponding dimension, for example the outside diameter, of the sealant and the optional follower, whereby the sealant and the optional follower are retained in the passageway of the body by the second end of the passageway. In other words, the sealant and the optional follower may be inserted into and removed from the passageway of the body from only one end.

In one example, the passageway of the body comprises a seat and wherein the passageway of the body is adapted to retain the sealant in contact with a surface of the seat, for example wherein dimensions, for example inner and outer diameters of the seat, are compatible with corresponding dimensions of the sealant, for example inner and outer diameters of the sealant. In other words, the sealant is axially compressed against the surface of the seat, in the second configuration.

In one example, the surface of the seat comprises and/or is a frustoconical surface, for example having a taper angle in a range from 30° to 60°, preferably in a range from 40° to 50°, for example 45°. In this way, the sealant is axially compressed against the surface of the seat, in the second configuration, and radially compresses inwards against the element.

In one example, the passageway of the body comprises a first portion having a first inside diameter corresponding with an outside diameter of the element (for example, a clearance fit) and optionally a third portion having a third inside diameter corresponding with an outside diameter of the follower and optionally, a second portion therebetween. In this way, the element may be received through the first portion, the second portion and the third portion of the passageway of the body, while the optional follower may be received in the third portion but not received in the first portion. In this way, the optional follower is retained, by the first portion, in the passageway of the body. It should be understood that similarly, the sealant may be received in the third portion but not received in the first portion. In this way, the sealant is retained, by the first portion, in the passageway of the body.

In one example, the first portion of the passageway of the body has a first length in a range from 5% to 100%, preferably in a range from 10% to 50%, more preferably in a range from 20% to 50% of the first inside diameter and/or wherein the third portion of the passageway of the body has a third length in a range from 100% to 500%, preferably in a range from 150% to 400%, more preferably in a range from 200% to 300% of the first inside diameter and/or wherein the body has a length in a range from 100% to 750%, preferably in a range from 200% to 600%, more preferably in a range from 300% to 500% of the first inside diameter. In this way, the body is relatively compact (i.e. physically small) in relation to the first inside diameter corresponding with the outside diameter of the element.

Cap assembly

The cap assembly comprises the cap and optionally the follower, having respective passageways therethrough for receiving the element therethrough. It should be understood that a dimension, for example an inner diameter, of the respective passageways of the cap assembly are thus at least a corresponding dimension, for example an outer diameter, of the element. In one example, the respective passageways of the cap assembly have circular cross-sections. Cap assemblies, comprising caps and followers, for cable glands are known.

### Cap

The cap assembly comprises the cap.

The cap is releasably couplable to the body. In this way, the cap may be coupled to and uncoupled from the body, for example repeatedly. That is, the feedthrough may be assembled and disassembled, for example repeatedly.

In one example, the cap and the body comprise mating threaded portions and wherein the cap is releasably couplable to the body using the mating threaded portions. In this way, the cap and the body may be coupled by rotating the cap around the axis relative to the body, thereby threading the cap towards the body until the matching faces of the cap assembly and the body abut. The feedthrough is thus held in the second configuration by the mating threaded portions. In one example, the cap comprises an externally threaded portion and the body comprises a mating internally threaded portion, or vice versa.

In one example, the cap and the body comprise mating bayonet portions and wherein the cap is releasably couplable to the body using the mating bayonet portions. In this way, the cap and the body may be coupled by sliding the cap, for example axially, onto the body until the matching faces of the cap assembly and the body abut and then rotating the cap around the axis relative to the body, so as to hold the feedthrough in the second configuration. In one example, the cap comprises a female bayonet portion and the body comprises a mating male bayonet portion, or vice versa.

In one example, the cap and the body comprise mating push-fit (i.e. interference fit) portions and wherein the cap is releasably couplable to the body using the mating push-fit portions. In this way, the cap and the body may be coupled by sliding the cap, for example axially, onto the body until the matching faces of the cap assembly and the body abut. The feedthrough is thus held in the second configuration by the mating push-fit portions. In one example, the cap comprises a female portion and the body comprises a mating male portion, or vice versa.

In one example, the passageway of the cap comprises a first portion having a first inside diameter corresponding with an outside diameter of the element and optionally a third portion having a third inside diameter corresponding with an outside diameter of the follower and optionally, a second portion therebetween. In this way, the element may be received through the first portion, the second portion and the third portion of the passageway of the cap, while the optional follower may be received in the third portion but not received in the first portion. In this way, the optional follower is retained, by the first portion, in the passageway of the cap.

In one example, the first portion of the passageway of the cap has a first length in a range from 100% to 500%, preferably in a range from 150% to 400%, more preferably in a range from 200% to 300% of the first inside diameter and/or wherein the third portion of the passageway of the cap has a third length in a range from 100% to 500%, preferably in a range from 150% to 400%, more preferably in a range from 200% to 300% of the first inside diameter and/or wherein the cap has a length in a range from 200% to 1000%, preferably in a range from 300% to 750%, more preferably in a range from 400% to 500% of the first inside diameter. In this way, the cap is relatively compact (i.e. physically small) in relation to the first inside diameter corresponding with the outside diameter of the element.

In one example, the cap comprises a first face and a second face, opposed to the first face, wherein the first face contacts the follower, in the second configuration. That is, the first face and the second face are disposed at or towards opposed ends of the cap. In this way, in the second configuration, wherein the matching faces of the cap assembly and the body abut, the first face of the cap contacts the follower while the cap assembly axially compresses the sealant against the body. In one example, in the second configuration, the first face of the cap contacts the follower which in turn axially compresses the sealant against the body. That is, the follower is disposed axially between the cap and the sealant.

In one example, the first face of the cap comprises and/or is an end face. In this way, the end face of the cap contacts the follower, in the second configuration, wherein the matching faces of the cap assembly and the body abut.

In one example, the cap comprises and/or is a cable gland or a part thereof. Cable glands are known. In one example, the cap is obtained from a standard cable gland, for example without any further adaptation thereto. In this way, a cost and/or a complexity of the feedthrough is reduced, since the cap may be obtained from a standard cable gland.

In one example, the cable gland is a screen connection cable gland. In this way, the cable gland is suitable for a coaxial cable. Typically, a screen connection cable gland comprises a plurality of components arranged to electrically connect against the screen of the coaxial cable.

### Follower

The cap assembly optionally comprises the follower. It should be understood that the follower is disposed axially between the cap and the sealant, in the second configuration, wherein the cap axially compresses the follower against the sealant which is in turn actually compressed against the body. Generally, the follower spaces the cap apart from the sealant, such that rotation of the cap relative to the follower and/or the sealant, for example, is not transmitted to the sealant. In other words, the follower provides a buffer, as known to the person skilled in the art. In one example, the cap assembly comprises a plurality of followers.

In one example, wherein the follower comprises a first face and a second face, opposed to the first face, wherein the first face contacts the sealant and wherein the second face contacts the cap, in the second configuration. That is, the follower is axially disposed between the cap and the sealant, in the second configuration. It should be understood that the follower is axially disposed between the cap and the sealant, in the first configuration, notwithstanding that at least one of the first face and the second face of the follower do not contact the sealant or the cap, respectively.

In one example, the second face of the follower comprises and/or is a shoulder, for example an external shoulder. That is, in the second configuration, the shoulder of the follower contacts the cap.

In one example, the passageway of the follower has an inside diameter corresponding with an outside diameter of the element, for example providing a clearance fit therebetween.

### Sealant

The feedthrough comprises the sealant, having the passageway therethrough for receiving the element therethrough. In the second configuration, the sealant is axially compressed against the body and radially compressed against the element, to form a hermetic seal between the body and the element. That is, dimensions of the sealant are changed, for example reversibly, by moving the feedthrough to the second configuration. In one example, the passageway of the sealant has an inside diameter less than an outside diameter of the element, for example providing an interference fit therebetween.

In one example, the sealant comprises and/or is a static radial seal, for example a ring seal such as an O-ring or a tapered ring. In one example, the sealant comprises and/or is a resilient seal, for example formed from an elastomeric material, for example a synthetic rubber such as a thermoset or a thermoplastic. Thermosets include: butadiene rubber (BR); butyl rubber (IIR); chlorosulfonated polyethylene (CSM); epichlorohydrin rubber (ECH; ECO); ethylene propylene diene monomer (EPDM); ethylene propylene rubber (EPR); fluoroelastomer (FKM); nitrile rubber (NBR; HNBR; HSN; Buna-N); perfluoroelastomer (FFKM); polyacrylate rubber (ACM); polychloroprene (neoprene) (CR); polyisoprene (IR); polysulfide rubber (PSR); polytetrafluoroethylene (PTFE); sanifluor (FEPM); silicone rubber (SiR); fluorosilicone rubber; and styrene-butadiene rubber (SBR). Thermoplastics include: thermoplastic elastomer (TPE) styrenics; thermoplastic polyolefin (TPO) LDPE, HDPE, LLDPE, ULDPE; thermoplastic polyurethane (TPU) polyether; polyestet; thermoplastic etheresterelastomers (TEEEs) copolyesters; thermoplastic polyamide (PEBA); melt Processible Rubber (MPR); and thermoplastic Vulcanizate (TPV).

In one example, the sealant is compressed, with respect to cross-sectional area, by a compression (also known as squeeze) in a range from 5% to 50%, preferably in a range from 10% to 40%, more preferably in the range from 15% to 30%, for example 20%, when the feedthrough is configured in the second configuration.

In one example, the sealant comprises a lubricant, for example a vacuum grease, on a surface thereof. In this way, a leakage rate is improved.

In one example, a ratio of a cross-sectional diameter of the sealant to a diameter of the element (i.e. the outer diameter of the element where contacted by the sealant) is in a range from 1:10 to 2:1, preferably in a range from 1:5 to 1:1:1, more preferably in a range from 1:5 to 1:2, for example about 1:2 or about 1:3. That is, this ratio is relatively independent of the diameter of the element.

### Configurations

The feedthrough is configurable in the first configuration and in the second configuration, for example repeatedly. In this way, the feedthrough may be assembled, disassembled and reassembled, for example for servicing.

First configuration

The feedthrough is configurable in the first configuration, wherein the cap is coupled to the body, wherein matching faces of the cap assembly and the body are mutually spaced apart by a gap and wherein the element extends through the respective passageways. That is, the first configuration is a partially assembled configuration, before the feedthrough is moved to the second configuration, such as during assembly or reassembly of the feedthrough. It should be understood that the gap is a void or a space between the matching faces. It should be understood that the matching faces are adapted to abut in the second configuration, as described below.

Second configuration

The feedthrough is configurable in the second configuration, wherein the cap is coupled to the body, wherein the matching faces of the cap assembly and the body abut and wherein the element extends through the respective passageways. That is, the second configuration is an assembled, for example a completely assembled, configuration, such as after assembly or reassembly of the feedthrough, in which the feedthrough is hermetically sealed. In other words, the second configuration is an in-use configuration for the vessel.

In one example, the matching faces of the cap assembly and the body are external faces (i.e. proximal or at an outer diameter and/or visible and/or exposed outwardly in the first configuration, such that an interface therebetween is proximal or at an outer diameter and/or visible outwardly, for example as a circumferential line, in the second configuration) of the cap assembly and the body, respectively. In this way, verification that the feedthrough is configured in the second configuration, in which the feedthrough is hermetically sealed, is provided by visual inspection. In other words, if there is a gap between the matching faces, the feedthrough is configured in the first configuration while the absence of a gap (i.e. abutment of the matching faces) confirms that the feedthrough is configured in the second configuration. Visual inspection is provided since the matching faces are external faces and hence the presence or absence of a gap (conversely non-abutment or abutment of the matching faces, respectively) is readily observable by an engineer, for example during installation, maintenance and/or quality control inspection. The inventors have determined that such visual inspection has eliminated occurrences of errors associated with conventional feedthroughs, hermetic sealing of which may not be verified by visual inspection. In contrast, if the matching faces are internal faces, visual inspection is not possible. Additionally and/or alternatively, installation of the feedthrough is facilitated since an engineer may move the matching faces of the cap assembly and the body until the matching faces abut, as monitored by visual inspection. The inventors have determined that such monitoring by visual inspection during installation has eliminated occurrences of errors during installation associated with conventional feedthroughs and/or is more reliable than, for example, tightening a conventional feedthrough to a pre-determined torque, which requires availability of a calibrated tool. Additionally and/or alternatively, if an engineer is unable to move the feedthrough to the second configuration, such that a gap remains between the matching faces, this is readily observable by the engineer and indicates that remedial action is required, for example the element and the feedthrough are mutually incompatible (such as oversized element or incorrectly selected feedthrough). Additionally and/or alternatively, in this way, relatively fewer components are required compared with a conventional feedthrough and/or simplicity is enhanced. Additionally and/or alternatively, if the cap assembly and body comprise mating threaded portions, a diameter of the threaded portions is relatively smaller than a diameter of the matching faces thereof, thereby reducing an overall diameter and/or mass of the feedthrough, for example such that through holes for mechanical fasteners in the body may be relatively more proximal the axis thereof. Additionally and/or alternatively the threaded portion of the body may be provided as an external threaded portion, thereby facilitating manufacture thereof.

In one example, the matching faces of the cap assembly and the body are provided by the cap and the body, respectively, as described with respect to the cap assembly and the body mutatis mutandis. For example, the matching faces may be external faces of the cap and the body, respectively. In one example, in the first configuration, the cap is coupled to the body, wherein matching faces of the cap and the body are mutually spaced apart by the gap and wherein the element extends through the respective passageways. That is, the matching faces are of the cap and the body, respectively. In one example, the matching faces of the cap assembly and the body are provided by an end face and a shoulder of the cap and the body, respectively.

In one example, the matching faces of the cap assembly and the body are provided by the follower and the body, respectively. For example, the matching faces may be internal faces (i.e. within the respective passageways) of the cap and the body, respectively. In one example, in the first configuration, the cap is coupled to the body, wherein matching faces of the follower and the body are mutually spaced apart by the gap and wherein the element extends through the respective passageways. That is, the matching faces are of the follower and the body, respectively. In one example, the matching faces of the cap assembly and the body are provided by an end face and a shoulder of the follower and the body, respectively.

In one example, in the second configuration, the cap is coupled to the body, wherein the matching faces of the cap and the body abut and wherein the element extends through the respective passageways.

In one example, in the second configuration, the matching faces of the cap assembly and the body abut directly i.e. without any component, such as a spacer or washer, therebetween. It should be understood that a lubricant, for example, may be provided between the matching faces of the cap assembly and the body, such as to facilitate moving between the first configuration and the second configuration.

Hermetic seal

The cap assembly is adapted to axially compress the sealant against the body, thereby causing the sealant to radially compress against the element and to form a hermetic seal between the body and the element, in the second configuration. That is, the second configuration is an assembled, for example a completely assembled, configuration, such as after assembly or reassembly of the feedthrough, in which the feedthrough is hermetically sealed. In other words, the second configuration is an in-use configuration for the vessel. It should be understood that the sealant is disposed axially between the body and the cap assembly in the second configuration (and in the first configuration). In one example, a first end of the sealant contacts the body, for example a seat thereof, and an opposed second end of the sealant contacts a face of the cap assembly, for example a face of the follower, in the second configuration.

In one example, the cap assembly is adapted to axially compress the sealant against the body by controlling an axial strain imposed thereupon, for example by axially compressing the sealant against the body by a predetermined axial strain when the matching faces of the cap assembly and the body abut. In one example, a first side of the sealant contacts the body, for example a seat thereof, and an opposed second side of the sealant contacts a face of the cap assembly, for example a face of the follower, in the second configuration and the predetermined axial strain is defined, at least in part, by an axial length between the body and the face of the cap assembly in contact with the sealant. In one example, an axial length from the matching, abutting face of the cap assembly to the face of the cap assembly in contact with the sealant is predetermined, to thereby define the predetermined axial strain.

In one example, the cap is adapted to axially compress the sealant between the follower and the body, thereby causing the sealant to radially compress against the element and to form the hermetic seal between the body and the element, in the second configuration.

In one example, the hermetic seal between the body and the element in the second configuration has a leakage rate defined by the permeability rate of a gas of interest through the sealant. That is, the permeability of the sealant determines the hermetic seal. In one example, the hermetic seal between the body and the element in the second configuration is compatible with a vacuum of better than 1E-5 mbar, preferably better than 1E-6 mbar, more preferably better than 1E-7 mbar.

### Moving

In one example, the feedthrough is arranged to move from the first configuration to the second configuration by rotating the cap relative to the body about the axis. In one example, the cap and the body comprise mating threaded portions, wherein the cap is releasably couplable to the body using the mating threaded portions and wherein the feedthrough is arranged to move from the first configuration to the second configuration by rotating the cap relative to the body about the axis, thereby threading the cap onto the body and thus moving the matching faces of the cap assembly and the body mutually together. It should be understood that when the matching faces of the cap assembly and the body abut, in the second configuration, further rotation of the cap relative to the body about the axis may be thus prevented, thereby indicating that the feedthrough is in the second configuration. It one example, the cap comprises a clutch whereby further rotation of the clutch relative to the body about the axis is possible in the second configuration.

### Materials

Generally, materials for the feedthrough, particularly the cap assembly and the body, may be selected according to the element and/or the wall, as known by the person skilled in the art.

Kit of parts

A second aspect provides a kit of parts comprising a feedthrough according to the first aspect and an element, for example an electrical cable such as a coaxial cable, a fibre optical cable or a pipe such as a capillary tube.

The feedthrough and/or the element may be as described with respect to the first aspect.

### Vessel

A third aspect provides a hermetically-sealed vessel, for example a vacuum chamber or a mass spectrometer, comprising a feedthrough according to the first aspect and an element, for example an electrical cable such as a coaxial cable, a fibre optical cable or a pipe such as a capillary tube.

The vessel, the feedthrough and/or the element maybe as described with respect to the first aspect

### Method

A fourth aspect method of hermetically sealing an element through a wall of a hermetically-sealed vessel having an aperture for the element therethrough using a feedthrough according to the first aspect, the method comprising:

moving the feedthrough from the first configuration to the second configuration, until the matching faces of the cap assembly and the body abut, comprising axially compressing the sealant between the cap assembly and the body, thereby compressing the sealant radially against the element and forming a hermetic seal between the body and the element.

The element, the wall, the vessel, the aperture, the feedthrough, the first configuration, the second configuration, matching faces, the cap assembly, the body, the sealant and/or the hermetic seal may be described with respect to the first aspect

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A schematically depicts an axial cross-section of a feedthrough according to an exemplary embodiment, in use; and FIG. 1B schematically depicts an axial exploded cross-section of the feedthrough of FIG. 1A;

FIG. 2A schematically depicts an axial cross-section of the cap of the feedthrough of FIG. 1A; and FIG. 2B schematically depicts an axial cross-section of the cap of the feedthrough of FIG. 2A, in use;

FIG. 3 schematically depicts an axial cross-section of the follower of the feedthrough of FIG. 1A;

FIG. 4 schematically depicts an axial cross-section of the sealant of the feedthrough of FIG. 1A;

FIG. 5 schematically depicts an axial cross-section of the body of the feedthrough of FIG. 1A; and

FIG. 6 schematically depicts an axial cross-section of the face seal of the body of the feedthrough of FIG 1A.

### DETAILED DESCRIPTION OF THE DRAWINGS

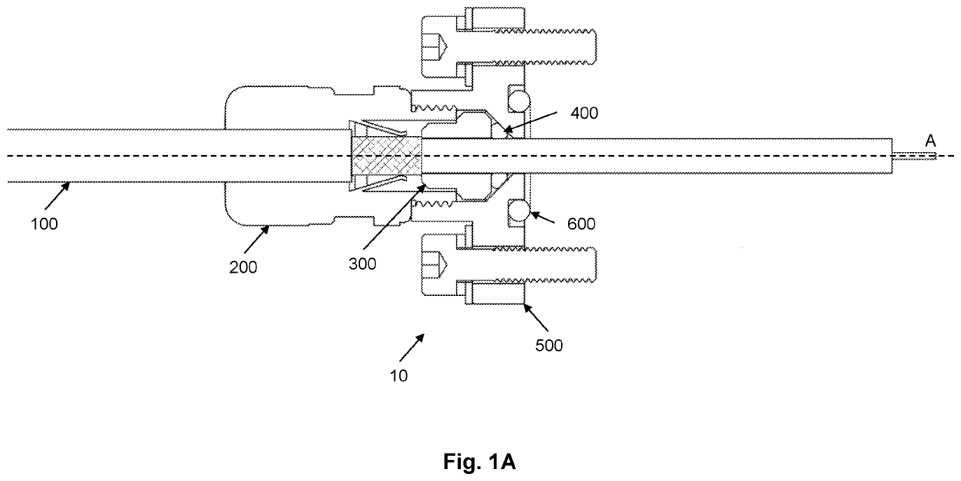

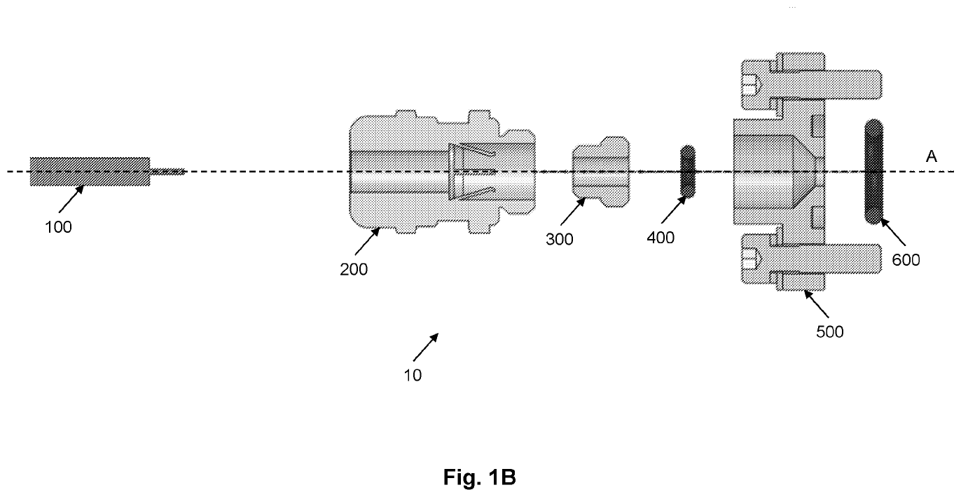

FIG. 1A schematically depicts an axial cross-section of a feedthrough 10 according to an exemplary embodiment, in use; and FIG. 1B schematically depicts an axial exploded cross-section of the feedthrough 10 of FIG. 1A.

The feedthrough 10 is for an element 100, comprising:

a body 500, a cap assembly, comprising a cap 200 and optionally a follower 300, and a sealant 400, having respective passageways therethrough, defining an axis A, for receiving the element 100 therethrough;

wherein the body 500 is couplable to a wall W (not shown) of a hermetically-sealed vessel V (not shown) having an aperture A for the element 100 therethrough and wherein the passageway of the body 500 is adapted to retain, at least in part, the sealant 400 and optionally the follower 300 therein;

wherein the cap 200 is releasably couplable to the body 500;

wherein the feedthrough 10 is configurable in:

a first configuration, wherein the cap 200 is coupled to the body 500, wherein matching faces of the cap assembly and the body 500 are mutually spaced apart by a gap and wherein the element 100 extends through the respective passageways; and

a second configuration, wherein the cap 200 is coupled to the body 500, wherein the matching faces 230, 520 of the cap assembly and the body 500 abut and wherein the element 100 extends through the respective passageways;

wherein the cap assembly is adapted to axially compress the sealant 400 against the body 500, thereby causing the sealant 400 to radially compress against the element 100 and to form a hermetic seal between the body 500 and the element 100, in the second configuration.

In this example, the hermetic seal between the body 500 and the element 100 is compatible with a vacuum of 5E-8 mbar in the vessel V. In this example, the sealant 400 is compressed, when the feedthrough 10 is configured in the second configuration, by about 20% with respect to cross-sectional area, particularly from a circular cross-section to a generally triangular cross-section. In this example, the element 100 is a coaxial cable and the feedthrough 10 is suitable for high voltages up to 25 KV, without using ceramic insulators, for example. In this example, the feedthrough 10 has an overall length of about 34 mm, excluding the element 100, which has a length of about 1 m. In this example, the minimum bend radius of the element 100 about 90° at the feedthrough 10, when the feedthrough 10 is configured in the second configuration, is 50 mm.

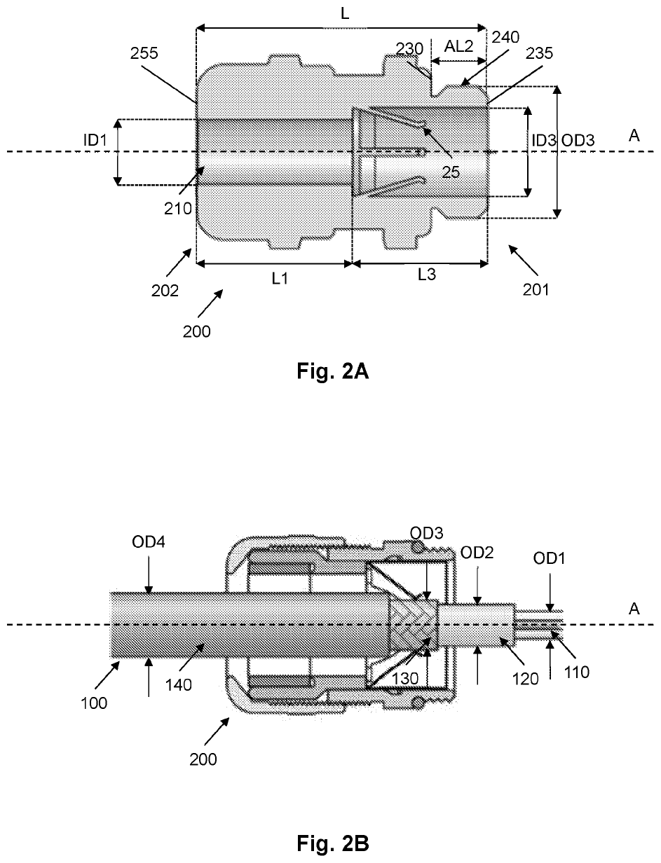

FIG. 2A schematically depicts an axial cross-section of the cap 200 of the feedthrough 10 of FIG. 1A; and FIG. 2B schematically depicts an axial cross-section of the cap 200 of the feedthrough 10 of FIG. 2A, in use. Particularly, FIG. 2B shows the cap 200 in more detail.

In this example, the cap 200 and the body 500 comprise mating threaded portions 240, 540 and wherein the cap 200 is releasably couplable to the body 500 using the mating threaded portions 240, 540. In this example, the cap 200 comprises an externally threaded portion 240, having an outside diameter OD3.

In this example, the passageway 210 of the cap 200 comprises a first portion having a first inside diameter ID1 corresponding with an outside diameter OD4 of the element 100 and a third portion having a third inside diameter OD3 corresponding with an outside diameter OD2 of the follower 300.

In this example, the first portion of the passageway 210 of the cap 200 has a first length L1 of about 250% of the first inside diameter ID1. In this example, the third portion of the passageway 210 of the cap 200 has a third length L3 of about 200% of the first inside diameter ID1. In this example, the cap 200 has a length L of about 450% of the first inside diameter ID1.

In this example, the cap 200 has an outside diameter of 15.98 mm.

In this example, the cap 200 comprises a first face 235 and a second face 255, opposed to the first face 235, wherein the first face 235 contacts the follower 300, in the second configuration. In this example, in the second configuration, the first face 235 of the cap 200 contacts the follower 300 which in turn axially compresses the sealant 400 against the body 500. In this example, the first face 235 of the cap 200 is an end face. In this example, an axial length between the matching face 230 and the first face 235 is AL2.

In this example, the cap 200 is a part of a cable gland. In this example, the cable gland is a screen connection cable gland. In this example, the cap 200 is obtained from a Skintop MS-SC-M cable gland, M12×1.5, 3.5 mm, 7 mm (53112610). FIG. 2B shows the details components of the cap 200 obtained from the Skintop MS-SC-M cable gland.

In this example, the element 100 is a coaxial cable comprising an inner conductor 110, surrounded by a concentric conducting screen 130, a dielectric 120 therebetween and, a protective outer sheath 140. In this example, the inner conductor 110 has an outside diameter OD1 of 0.75 mm, the dielectric 120 has an outside diameter OD2 of 3.95 mm, the screen 130 has an outside diameter OD3 and the sheath 140 has an outside diameter OD4 of 6.15 mm.

In this example, the element 100 is a Belden Black Unterminated to Unterminated RG59B/ U Coaxial Cable, 75 Ω6.15 mm OD.

In this example, the element 100 is stripped partially of the outer sheath 140 such that the cap 200 connects electrically against the screen 130 via fingers 25. In this example, the element 100 is stripped partially also of the screen 130 beyond the first end of the cap 201, opposed to the second end of the cap 202.

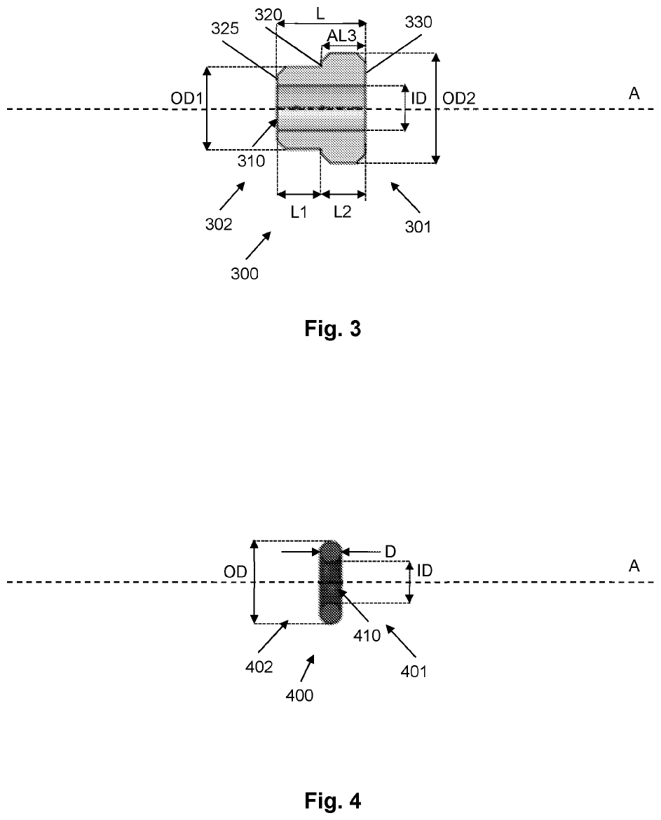

FIG. 3 schematically depicts an axial cross-section of the follower 300 of the feedthrough 10 of FIG. 1A.

Generally, the follower 300, of length L, has the passageway 310 there through from a first end 301 to a second end 302. An inside diameter ID of the passageway 310 is constant. An outside diameter of the follower 300 is stepped, having a relatively larger outside diameter OD2, of length L2, relatively more proximal the first end 301 and a relatively smaller outside diameter OD1, of length L1, relatively more proximal the second end 302. External edges are chamfered.

The follower 300 has a first face 330 at the first end 301, a third face 325 opposed to the first face 330 at the second end 302 and a second face 320, opposed to the first face 330 and provided by a shoulder, therebetween.

In this example, the follower 300 comprises the first face 330 and the second face 320, opposed to the first face 330, wherein the first face 330 contacts the sealant 400 and wherein the second face 320 contacts the cap 200, in the second configuration. In this example, an axial length between the first face 330 and the second face 320 is AL3.

In this example, the second face 320 of the follower 300 is an external shoulder.

In this example, the passageway 310 of the follower 300 has an inside diameter ID corresponding with an outside diameter OD of the element 100.

In this example, the cap assembly is adapted to axially compress the sealant 400 against the body 500 by controlling an axial strain imposed thereupon, by axially compressing the sealant 400 against the body 500 by a predetermined axial strain when the matching faces 230, 520 of the cap assembly and the body 500 abut. In this example, a first side 401 of the sealant 400 contacts the body 500, in this example a seat 515 thereof, and an opposed second side 402 of the sealant 400 contacts a face of the cap assembly, in this example a face 330 of the follower 300, in the second configuration and the predetermined axial strain is defined, at least in part, by an axial length between the body 500, in this example the seat 515, and the face 330 of the cap assembly in contact with the sealant 400. In this example, an axial length (AL2 +AL3) from the matching, abutting face 230 of the cap assembly to the face 330 of the cap assembly in contact with the sealant 400 is predetermined, to thereby define the predetermined axial strain.

FIG. 4 schematically depicts an axial cross-section of the sealant 400 of the feedthrough 10 of FIG. 1A.

The feedthrough 10 comprises the sealant 400, having the passageway 410 therethrough for receiving the element 100 therethrough. In this example, the passageway 410 of the sealant 400 has an inside diameter ID less than an outside diameter OD of the element 100, particularly the outside diameter OD2 of the dielectric 120, for example providing an interference fit therebetween. In this example, a first end 401 of the sealant 400 contacts the body 500, in this example a seat 515 thereof, and an opposed second end 402 of the sealant 400 contacts a face of the cap assembly, in this example a first face 330 of the follower 300, in the second configuration.

In this example, the sealant 400 is an O-ring, particularly an O-ring 3.7 mm ID 1.9CS FKM i.e. having an inside diameter ID of 3.7 mm, a cross-sectional diameter D of 1.9 mm and an outside diameter OD of 7.5 mm. In this example, the sealant 400 is installed on and contacts the dielectric 120, of the element 100, having an outside diameter OD2 of 3.95 mm. In this example, the sealant 400 is arrange to be compressed by about 20% by cross-sectional area in the second configuration.

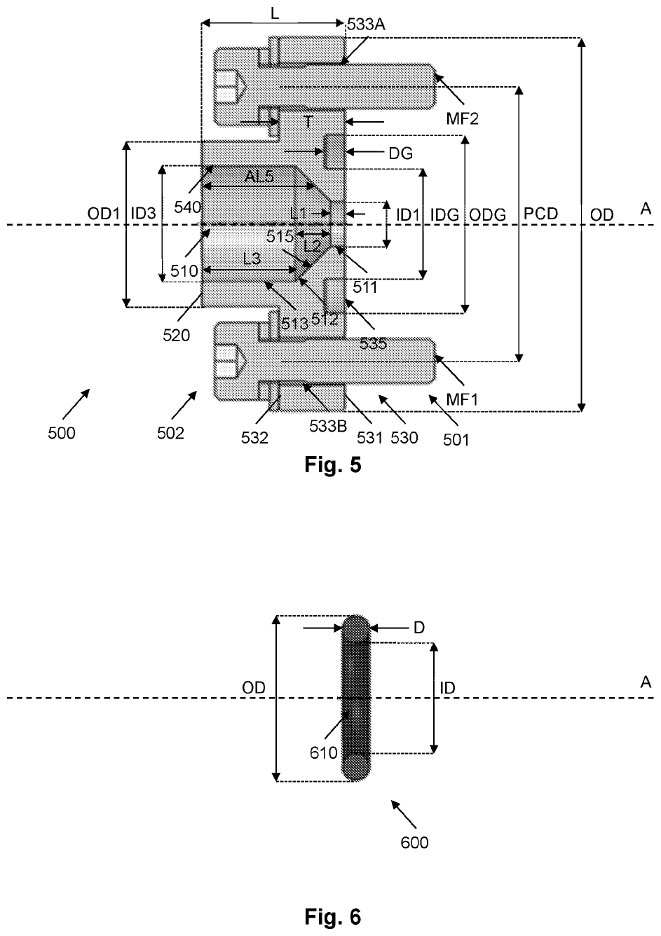

FIG. 5 schematically depicts an axial cross-section of the body 500 of the feedthrough 10 of FIG. 1A.

Generally, the body 500 has the passageway 510 therethrough from a first end 501 to a second end 502. The body 500 has a flange 530 at the first end 501 for coupling to the wall W. The passageway 510 has a stepped bore, having a relatively larger inside diameter ID3 at the second end 502 compared with the relatively smaller inside diameter ID1 at the first end 501. The step between the relatively larger inside diameter ID3 and the relatively smaller inside diameter ID1 is tapered and provides a seat 515 for the sealant 400. The relatively smaller inside diameter ID1 retains the sealant 400 and the follower 300 in the passageway 510 with respect to the first end 501. The body 500 comprises a mating internally threaded portion 540, in the passageway 510, for coupling to the cap 200. A face 520 at the second end 502 provides a matching face, for abutting against the cap assembly in the second configuration.

The body 500 has the passageway 510 therethrough for receiving the element 100 therethrough. In this example, the passageway 510 of the body 500 has a circular cross-section, including a first portion 511 having a relatively shorter length L1 and a relatively smaller internal diameter ID1 proximal the first end 501, a third portion 513 having a relatively longer length L2 and a relatively larger internal diameter ID3 proximal the second end 502 and a second portion 512, having a length L2, tapering therebetween. In this example, the body 500 has a length L of 13.0 mm.

In this example, the body 500 is arranged to be mechanically coupled to the wall W.

In this example, the body 500 is arranged to be mechanically coupled to the wall W by comprising the flange 530, having a first face 531 and an opposed second face 532, comprising a set of through holes 533A, 533B, 533C (not shown), 533D (not shown) for mechanical fasteners MF1, MF2, MF3 (not shown), MF4 (not shown), wherein the first face 531 is arranged to confront the wall W and wherein the feedthrough 10 assembly comprises a face seal 600 (i.e. a static axial seal) for hermetically-sealing between the first face 531 and the wall W.

In this example, the flange 530 has an outside diameter OD of 34.0 mm and a thickness T of 6.0 mm. In this example, the set of through holes 533A, 533B, 533C, 533D are mutually equispaced at a diameter PCD. In this example, the mechanical fasteners MF1, MF2, MF3, MF4 are cap head bolts, each having two washers.

In this example, the face seal 600 is an O ring, particularly an O-ring 10 mm ID 2.5CS FKM.

In this example, the first face 531 comprises a groove 535 around the passageway 510, arranged to receive the face seal 600.

In this example, the groove 535 has a depth DG in the first face 531 of the flanged 530, an outside diameter ODG and an inside diameter IDG, corresponding with the face seal 600.

The passageway 510 of the body 500 is adapted to retain, at least in part, the sealant 400 and the follower 300 therein, by having a first dimension ID3, particularly an inside diameter ID3, at a first end 502 greater than a corresponding dimension, for example an outside diameter OD1, of the sealant 400 and the follower 300, whereby the sealant 400 and the follower 300 may be received therein via the first end 502 of the passageway 510 and a second dimension, for example an inside diameter ID1, at a second end 501 less than the corresponding dimension, for example the outside diameter, of the sealant 400 and the follower 300, whereby the sealant 400 and the optional follower 300 are retained in the passageway 510 of the body 500 by the second end 502 of the passageway 510.

In this example, the passageway 510 of the body 500 comprises the seat 515 and wherein the passageway 510 of the body 500 is adapted to retain the sealant 400 in contact with a surface of the seat 515. In this example, the surface of the seat 515 is a frustoconical surface, having a taper angle of about 45°.

In this example, the passageway of the body 500 comprises a first portion having a first inside diameter ID1 corresponding with an outside diameter OD of the element 100, particularly the outside diameter OD to of the dielectric 120, (for example, a clearance fit) and a third portion having a third inside diameter ID3 corresponding with an outside diameter of the follower 300 and a second portion therebetween.

In this example, the first portion of the passageway 510 of the body 500 has a first length L1 of about 25% of the first inside diameter ID1. In this example, the third portion of the passageway 510 of the body 500 has a third length L3 of about 250% of the first inside diameter ID1. In this example, the second portion of the passageway 510 of the body 500 has a second length L2 of about 100% the first inside diameter ID1. In this example, the body 500 has a length of about 375% of the first inside diameter ID1.

In this example, the cap 200 and the body 500 comprise mating threaded portions 240, 540 and wherein the cap 200 is releasably couplable to the body 500 using the mating threaded portions 240, 540. In this example, the body 500 comprises a mating internally threaded portion 540, in the passageway 510.

In this example, the axial length between the matching face 520 and the seat 515 (at a midpoint thereof with respect to the sealant 400, since the seat 515 is tapered) is ALS. Hence, the predetermined axial strain applied on the sealant 400 in the second configuration is defined by an axial length [AL5−(AL2+AL3)] and the cross-sectional diameter D of the sealant 400.

FIG. 6 schematically depicts an axial cross-section of the face seal of the body 500 of the feedthrough 10 of FIG. 1A.

In this example, the face seal 600 is an O ring, particularly an O-ring 10 mm ID 2.5CS FKM, having an inside diameter ID of 10 mm, providing a passageway 610 therethrough, a cross-sectional diameter D of 2.5 mm and an outside diameter OD of 15 mm.

In this example, the element 100 is a Belden Black Unterminated to Unterminated RG59B/ U Coaxial Cable, 75 Ω 6.15 mm OD and the cap 200 is suitably sized and obtained from a Skintop MS-SC-M cable gland M12×1.5, 3.5 mm, 7 mm (53112610). The follower 300, the sealant 400, the body 500 and the face seal 600 are sized accordingly, including wherein dimensions thereof are predetermined, as described above, such that the hermetic seal is formed in the second configuration. It will be appreciated by those skilled in the art that feedthroughs maybe thus dimensioned suitably for different elements.

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A feedthrough for an element, comprising:
a body, a cap assembly, comprising a cap and optionally a follower, and a sealing member, having respective passageways therethrough, defining an axis, for receiving the element therethrough;
wherein the body is couplable to a wall of a hermetically-sealed vessel having an aperture for the element therethrough and wherein the passageway of the body is adapted to retain, at least in part, the sealing member and optionally the follower therein;
wherein the cap is releasably couplable to the body;
wherein the feedthrough is configurable in:
a first configuration, wherein the cap is coupled to the body, wherein matching faces of the cap assembly and the body are mutually spaced apart by a gap, wherein the matching faces of the cap assembly and the body are external faces of the cap assembly and the body respectively, and wherein the element extends through the respective passageways; and
a second configuration, wherein the cap is coupled to the body, wherein the matching faces of the cap assembly and the body abut and wherein the element extends through the respective passageways;
wherein the cap assembly is adapted to axially compress the sealing member against the body, thereby causing the sealing member to radially compress against the element and to form a hermetic seal between the body and the element, in the second configuration.

2. The feedthrough according to claim 1, wherein the body is arranged to be mechanically coupled or welded to the wall.

3. The feedthrough according to claim 2, wherein the body is arranged to be mechanically coupled to the wall by comprising a flange, having a first face and an opposed second face, comprising a set of through holes for mechanical fasteners, wherein the first face is arranged to confront the wall and wherein the feedthrough assembly comprises a face seal for hermetically-sealing between the first face and the wall.

4. The feedthrough according to claim 3, wherein the first face comprises a groove around the passageway, arranged to receive the face seal therein.

5. The feedthrough according to any previous claim, wherein the sealing member comprises and/or is a static radial seal.

6. The feedthrough according to any previous claim, wherein the cap and the body comprise mating threaded portions and wherein the cap is releasably couplable to the body using the mating threaded portions.

7. The feedthrough according to any previous claim, wherein the passageway of the body comprises a seat and wherein the passageway of the body is adapted to retain the sealing member in contact with a surface of the seat.

8. The feedthrough according to claim 7, wherein the surface of the seat comprises and/or is a frustoconical surface.

9. The feedthrough according to any previous claim, wherein the passageway of the body comprises a first portion having a first inside diameter corresponding with an outside diameter of the element, a third portion having a third inside diameter corresponding with an outside diameter of the follower and a second portion therebetween.

10. The feedthrough according to claim 9, wherein the first portion of the passageway of the body has a first length in a range from 5% to 100% of the first inside diameter and/or wherein the third portion of the passageway of the body has a third length in a range from 100% to 500% of the first inside diameter and/or wherein the body has a length in a range from 100% to 750% of the first inside diameter.

11. The feedthrough according to any previous claim, wherein the follower comprises a first face and a second face, opposed to the first face, wherein the first face contacts the sealing member and wherein the second face contacts the cap, in the second configuration.

12. The feedthrough according to claim 11, wherein the second face of the follower comprises and/or is an external shoulder.

13. The feedthrough according to any previous claim, wherein the passageway of the follower has an inside diameter corresponding with an outside diameter of the element.

14. The feedthrough according to any previous claim, wherein the passageway of the cap comprises a first portion having a first inside diameter corresponding with an outside diameter of the element, a third portion having a third inside diameter corresponding with an outside diameter of the follower and a second portion therebetween.

15. The feedthrough according to claim 14, wherein the first portion of the passageway of the cap has a first length in a range from 100% to 500% of the first inside diameter and/or wherein the third portion of the passageway of the cap has a third length in a range from 100% to 500% of the first inside diameter and/or wherein the cap has a length in a range from 200% to 1000% of the first inside diameter.

16. The feedthrough according to any previous claim, wherein the cap comprises a first face and a second face, opposed to the first face, wherein the first face contacts the follower, in the second configuration.

17. The feedthrough according to claim 16, wherein the first face of the cap comprises and/or is an end face.

18. The feedthrough according to any previous claim, wherein the cap comprises and/or is a cable gland or a part thereof.

19. The feedthrough according to claim 18, wherein the cable gland is a screen connection cable gland.

20. The feedthrough according to any previous claim, wherein the feedthrough is arranged to move from the first configuration to the second configuration by rotating the cap relative to the body about the axis.

21. The feedthrough according to any previous claim, wherein the matching faces of the cap assembly and the body are provided by an end face and a shoulder of the cap and the body or of the follower and the body, respectively.

22. The feedthrough according to any previous claim, comprising a biasing member arrangeable to bias the feedthrough in the second configuration.

23. A kit of parts comprising a feedthrough according to any previous claim and an element, wherein the element is selected from a group consisting of: an electrical cable, a fibre optical cable and a pipe.

24. A hermetically-sealed vessel comprising a feedthrough according to any of claims 1 to 22 and an element, wherein the element is selected from a group consisting of: an electrical cable, a fibre optical cable and a pipe.

25. A method of hermetically sealing an element through a wall of a hermetically-sealed vessel having an aperture for the element therethrough using a feedthrough according to any of claims 1 to 22, the method comprising:
moving the feedthrough from the first configuration to the second configuration, until the matching faces of the cap assembly and the body abut, comprising axially compressing the sealing member between the cap assembly and the body, thereby compressing the sealing member radially against the element and forming a hermetic seal between the body and the element.
